(19) United States
(12) Patent Application Publication
(10) Pub. No.: US 2025/0290540 A1
(43) Pub. Date: Sep. 18, 2025

(54) ROTARY SHAFT DEVICE WITH INTEGRATED COOLING AND LUBRICATION

(71) Applicants: AB SKF, Göteborg (SE); ALPINOV X, Grenoble (FR)

(72) Inventors: Domenico RESTAINO, Palaiseau (FR); Thomas CHARBONNEAU, Vourey (FR); Jérôme GIRARD, Grenoble (FR)

(73) Assignees: AB SKF, Göteborg (SE); ALPINOV X, Grenoble (FR)

(21) Appl. No.: 19/225,440

(22) Filed: Jun. 2, 2025

Related U.S. Application Data
(63) Continuation of application No. PCT/FR2023/051892, filed on Dec. 1, 2023.

(30) Foreign Application Priority Data
Dec. 2, 2022 (FR) 22/12719

(51) Int. Cl. F16C 3/02; F04D 29/043; F04D 29/059; F16C 37/00

(52) U.S. Cl. CPC F16C 3/02; F04D 29/043; F04D 29/059; F16C 37/007; F16C 2210/04; F16C 2360/00; F16C 2360/24

(57) ABSTRACT

A rotary shaft device includes a housing, a rotary shaft rotatably mounted relative to the housing, a pressurization member radially disposed between a main body of the rotary shaft and the housing, and at least one cooling channel. The pressurization member and the main body of the rotary shaft define between them a pressurization reservoir configured to receive a volume of a cooling fluid. The at least one cooling channel extends between a fluid inlet and a fluid outlet, has at least one component along the axis of rotation, and is in fluid communication, at the fluid inlet, with the pressurization reservoir.

### CROSS-REFERENCE TO RELATED APPLICATIONS

This application is a continuation of International Application No. PCT/FR2023/051892, filed on Dec. 1, 2023, which claims priority to and the benefit of FR 22/12719, filed on Dec. 2, 2022. The disclosures of the above applications are incorporated herein by reference.

### FIELD

The present disclosure relates to a rotary shaft cooling and lubrication device, a turbocharger including such a rotary shaft device, the turbocharger being capable of compressing a refrigerant, and a method for operating a rotary shaft device.

### BACKGROUND

The statements in this section merely provide background information related to the present disclosure and may not constitute prior art.

In the field of rotating machines, it is known to rotatably support a rotary shaft relative to a housing, by means of one or more rolling bearings, for example ball bearings. In this case, when the machine is put into operation, the inner ring of the rolling bearing, which is secured to the rotary shaft, is rotated relative to the outer ring, which is secured to the machine housing, by means of the balls. Generally speaking, when the rotary shaft is rotatably driven, a fluid can be injected to lubricate and cool the rolling bearings and the shaft (for example, to prevent overheating or the addition of heat to or from the shaft's surroundings). To prevent the fluid from spreading throughout the entire machine, particularly in the rolling bearings, the bearings can be fluidically isolated from the rest of the machine by seals. The presence of a fluid in a machine, due to its mixing by various moving members, particularly rolling bearings, can cause the fluid to deteriorate and overheat, cause friction losses, or cause poor performance of the members.

Although seals are satisfactory in that they limit fluid distribution within the machine, they are nevertheless responsible for additional friction during operation, which can lead to an increase in the internal temperature of the machine, causing mechanical deterioration or premature aging of its components. Such an increase in temperature can also be caused by the ball, roller, or needle rolling, and by any type of mechanical bearing. Another potential source of machine heating can also come from the shearing of a part of the lubrication oil, components attached to the shaft, or friction in the rolling bearings. A substantial increase in temperature can then cause an impairment in method performance, leading to machine malfunctions or a decrease in its accuracy, particularly due to the expansion of materials under the effect of heat.

This is particularly detrimental for systems reaching very high rotational speeds, for example, greater than 10,000 revolutions per minute, or more generally for systems reaching high values of the speed factor “n×dₘ” (where n is the rotational frequency in revolutions per minute, multiplied by dₘ, which is the average rolling bearing diameter in mm), which would typically exceed 400,000. In this case, even if a cooling oil is used, the rotational speed can cause it to shear, which is detrimental to the temperature and therefore to the operation of the machine. Indeed, to ensure proper cooling of the machine, it is necessary to have a high oil flow rate, accompanied by oil mixing, particularly to homogenize the temperature. When the oil is mixed, or when it is directed into other parts of the moving mechanism, the oil is sheared, which causes additional heating of the oil and therefore a loss of overall efficiency of the machine.

Thus, the lubrication of a rotary shaft can have two potentially sometimes conflicting functions which are the lubrication and cooling of the rolling bearings (or any other moving component or mechanism). Indeed, as previously indicated, excessive lubrication can cause significant shearing of the oil and thus drastically increase heating. The higher the oil flow rate in the rolling bearings, the greater the quantity of evacuated calories. Nonetheless, this heat capture is less effective at high flow rates, and it is generally necessary to implement proportionally very high flow rates to cool rolling bearings rotating at very high speeds. Indeed, these will generate significant heating, particularly due to the high shear of the oil.

### SUMMARY

This section provides a general summary of the disclosure and is not a comprehensive disclosure of its full scope or all of its features.

The purpose of the present invention is to propose a solution that addresses all or part of the aforementioned problems, in particular by allowing the separation of the cooling and lubrication functions of the oil.

This object can be achieved by implementing a rotary shaft device comprising: a housing; a rotary shaft surrounded by the housing, rotatably mounted relative to the housing about an axis of rotation, and having a geometry of revolution about said axis of rotation, said rotary shaft comprising a main body comprising a fluid receiving portion; at least one rolling bearing comprising rolling elements, and ensuring the mounting in rotation of the rotary shaft relative to the housing; a pressurization member belonging to the rotary shaft, and secured in rotation to the main body of the rotary shaft, said pressurization member being radially disposed between the main body of the rotary shaft and the housing, and axially positioned at the fluid receiving portion of the main body of the rotary shaft, said pressurization member and the main body of the rotary shaft defining between them a pressurization reservoir configured to receive a volume of a cooling fluid; and at least one cooling channel radially disposed between the main body of the rotary shaft and the at least one rolling bearing, and extending between a fluid inlet and a fluid outlet, said at least one cooling channel having at least one component along the axis of rotation, and being in fluid communication, at the fluid inlet, with the pressurization reservoir, said at least one cooling channel being configured to ensure heat transfer between the rotary shaft, said at least one rolling bearing, and the cooling fluid, when the cooling fluid flows along said cooling channel from the pressurization reservoir.

It is therefore understood that said at least one cooling channel ensures a fluid communication between the pressurization reservoir and the fluid outlet.

All of the previously described provisions make it possible to propose a rotary shaft device in which the pressurization reservoir places the cooling fluid at an overpressure relative to ambient pressure, at the fluid inlet, when the cooling fluid is subjected to a centrifugal force caused by the rotational movement of the rotary shaft about the axis of rotation.

The rotary shaft device may further have one or more of the following features, taken alone or in combination.

According to one embodiment, the at least one cooling channel is fluidically isolated from the rolling elements of the at least one rolling bearing.

The term “fluidically isolated”, means that the quantity of fluid used for lubrication, reaching the rolling elements of the at least one rolling bearing from the cooling channels or the pressurization reservoir, or even from a separate device, can be controlled via appropriate sizing or arrangement, independently of the flow supplying the pressurization reservoir and the cooling channels.

Thus, by separating the lubrication and cooling functions, and controlling the flow rates that this allows, it is possible to cool the rotary shaft device, limiting the risk of shearing, overheating, or degradation of the fluid in the case where this fluid is also used to lubricate the rolling elements of the at least one rolling bearing.

According to one embodiment, the rotary shaft delimits the at least one cooling channel.

According to one embodiment, the at least one rolling bearing is disposed between the rotary shaft and the housing.

According to one embodiment, the at least one rolling bearing is disposed between the pressurization member and the housing.

According to one embodiment, the pressurization member is offset axially along the axis of rotation relative to the at least one rolling bearing.

According to one embodiment, the a least one cooling channel is oriented axially relative to the axis of rotation.

According to one embodiment, the fluid receiving portion is arranged at one end, or in a stepped region of the rotary shaft.

According to one embodiment, the fluid receiving portion is arranged on a portion of the rotary shaft that has a diameter strictly smaller than an inner diameter of the at least one rolling bearing.

According to one embodiment, the fluid receiving portion is adjacent to a flow portion of the rotary shaft at which the at least one rolling bearing is arranged.

According to one embodiment, the fluid receiving portion is adjacent and in direct fluid connection without requiring communication holes to the flow portion including the at least one cooling channel.

According to one embodiment, each cooling channel forms a groove cut into the outer surface of the rotary shaft or into an attached ring secured in rotation to the shaft.

According to one embodiment, the configuration of each cooling channel depends at least in part on: the thermal conductivity of the cooling fluid and the materials constituting the rotary shaft; the Prandlt number of the cooling fluid; the flow rate of the cooling fluid corresponding to a thermal power to be evacuated.

According to one embodiment, the occupancy rate of the outer surface area by the cooling channels is comprised between 10% and 30%. In other words, the apparent surface area of the channels represents 10% to 30% of the outer surface area of the rotary shaft or of an attached ring secured to the shaft. Such an occupancy rate is selected to ensure sufficient Hertz pressure to ensure the clamping of the ring of the at least one rolling bearing on the rotary shaft.

According to one embodiment, a ratio of a spacing between two cooling channels and a width of a cooling channel is comprised between 2 and 10. In this way, it is possible to guarantee the absence of deformation of the raceway of the inner ring at the cooling channels.

According to one embodiment, the number of cooling channels and a width of a cooling channel depend on the thermal power to be removed and the characteristics of the cooling fluid.

According to one embodiment, the number of cooling channels is greater than or equal to two, and in particular greater than or equal to four.

According to one embodiment, the cooling channels are distributed radially and uniformly on the rotary shaft.

Advantageously, the use of a large number of cooling channels increases the flow rate of cooling fluid used to cool the entire rotary shaft device, particularly the rotary shaft and at least one rolling bearing.

Synergistically, the use of a large number of cooling channels in the form of fine grooves ensures cooling with a high flow rate, while limiting the pressure drop experienced by the cooling fluid. Moreover, the use of a large number of cooling channels increases the exchange surface area wetted by the cooling fluid and ensures better temperature uniformity. This also obviously increases the evacuated hot power. According to one embodiment, the pressurization member is secured to the rotary shaft.

According to one embodiment, the rotary shaft comprises the pressurization member.

According to one embodiment, the pressurization reservoir is configured to place the cooling fluid under overpressure relative to ambient pressure at the fluid inlet when the cooling fluid is subjected to centrifugal force caused by the rotational movement of the rotary shaft about the axis of rotation.

Generally, said overpressure may be greater than 1.5 bar, and more particularly between 2 bar and 10 bar, where 1 bar is equal to 10⁵ Pa. In particular, if the rotary shaft has a diameter substantially equal to 70 mm, and if the rotation speed is substantially equal to 12,000 rpm, said overpressure may be equal to 5 bars.

By substantially equal, is meant a value equal to within 10%.

According to one embodiment, the fluid receiving portion comprises a first part without a cooling channel, said first part of the fluid receiving portion preferably having a frustoconical shape.

Advantageously, the use of a fluid receiving portion having at least one portion having a frustoconical shape makes it possible to define a pressurization reservoir that generates a volume of cooling fluid in the form of a fluid ring when the cooling fluid is rotated. Thus, it is possible to generate hydrostatic overpressure at the fluid inlet. This hydrostatic overpressure depends in particular on a radially measured cooling fluid height in the pressurization reservoir, the outer diameter of the cooling channels, and the rotational speed of the rotary shaft.

According to one embodiment, the first part of the fluid receiving portion has a frustoconical, hemispherical, or stepped cylindrical shape. Advantageously, the first part facilitates the homogeneous rotation of the cooling fluid. Indeed, the synchronous rotation of the rotary shaft with the cooling fluid ensures efficient introduction of the cooling fluid into the cooling channels. The first part also prevents the occurrence of swirl or rebound phenomena leading to poor penetration of the cooling fluid into the cooling channels. Such phenomena are characterized by the fact that the rotational speed of the cooling fluid is greater over a portion radially located at the periphery than over a portion located closer to the axis of rotation. This first part is not, however, limiting; it is also possible for such a first part to be absent. It is also possible for the pressurization member to be a part attached to the main body of the rotary shaft between the axis of rotation and the housing, or for the pressurization member to be a collection groove included in the rotary shaft and communicating with the cooling channels. In this case, the rotary shaft may comprise collection channels, whether or not attached to the main body of the rotary shaft and extending radially relative to the axis of rotation. Thus, the function of pressurization the cooling fluid at the cooling reservoir is implemented when the cooling fluid supply is carried out at a supply end of said collection channels closest to the axis of rotation, the outlet of the cooling fluid opening into the collection groove forming the pressurization reservoir.

According to one embodiment, an air gap between the pressurization member and the rotary shaft, measured along an axis perpendicular to an outer surface of the first part of the fluid receiving portion, is axially constant along the first part of the fluid receiving portion.

According to one embodiment, the pressurization reservoir has a hollow frustoconical shape, whose hollow is formed at least partially by the first part of the fluid receiving portion. Thus, and advantageously, the shape of the pressurization reservoir both allows for overflow of the cooling fluid in the case that excessive injection of cooling fluid is carried out, and preventing cooling fluid backflow or a swirl effect, particularly during a rapid increase in the rotational speed of the rotary shaft. Synergistically, the truncated cone shape of the pressurization reservoir allows the cooling fluid to flow to the cooling channels, thereby bringing the cooling fluid to the inlet of the cooling channels for cooling fluid flow rates too low to allow the formation of a cooling fluid ring.

According to one embodiment, at least one element, selected from the group comprising the pressurization member and the first part of the fluid receiving portion, comprises orientation fins configured to more efficiently direct the cooling fluid toward the inlet of the flow zone containing the cooling channels.

According to one embodiment, the orientation fins are arranged on an outer surface of the first part of the fluid receiving portion.

According to one embodiment, each orientation fin has a helical shape.

According to one embodiment, the at least one cooling channel is provided on an outer surface of the main body of the rotary shaft.

According to one embodiment, the pressurization member comprises a proximal pressurization portion configured to cover the rotary shaft over a second portion of the fluid receiving portion, so as to externally radially close the at least one cooling channel.

According to one embodiment, the second part of the fluid receiving portion comprises cooling channels. In other words, at least one part of the outer surface of the rotary shaft is included in the second part of the fluid receiving portion, such that the cooling channels extend from the second portion of the fluid receiving portion to the flow portion and over all or part of the flow portion.

According to one embodiment, the proximal pressurization portion has a cylindrical shape, for example comprising a rim forming the pressurization reservoir for the cooling fluid.

According to one embodiment, the second part of the fluid receiving portion is at least partially threaded, so as to allow the pressurization member to be screwed onto the proximal pressurization portion.

According to one embodiment, the proximal pressurization portion is fitted or glued, so as to allow the pressurization member to be screwed onto the second part of the fluid receiving portion.

According to one embodiment, the proximal pressurization portion is at least partially threaded, so as to allow the pressurization member to be screwed onto the second part of the fluid receiving portion.

According to one embodiment, the second part of the fluid receiving portion extends, along the axis of rotation, the first part of the fluid receiving portion, in a direction approaching said at least one rolling bearing.

According to one embodiment, the first part of the fluid receiving portion and the second part of the fluid receiving portion are integrally formed within the same integral part forming the fluid receiving portion.

According to one embodiment, the pressurization member comprises a distal pressurization portion, distinct from the proximal pressurization portion, and having a geometry of revolution about the axis of rotation, converging up to the proximal pressurization portion.

According to one embodiment, the distal pressurization portion has a pressurization member thickness measured radially relative to the axis of rotation, which progressively decreases as it axially approaches the proximal pressurization portion.

According to one embodiment, the distal pressurization portion has a constant pressurization member thickness measured radially relative to the axis of rotation, and has an inner diameter measured radially relative to the axis of rotation that gradually decreases as it axially approaches the proximal pressurization portion.

According to one embodiment, said at least one cooling channel has a channel depth measured radially relative to the axis of rotation, and in which the pressurization reservoir has a storage height measured radially relative to the axis of rotation, said storage height being strictly greater than said channel depth.

According to one embodiment, the distal pressurization portion extends in the proximal pressurization portion along the axis of rotation, in a direction away from said at least one rolling bearing.

According to one embodiment, the distal pressurization portion and the proximal pressurization portion are integrally formed within the same integral part forming the pressurization member.

According to one embodiment, the at least one rolling bearing comprises an inner ring secured in rotation to the rotary shaft, said inner ring covering at least partially the at least one cooling channel.

It is therefore understood that the cooling channel is arranged under the inner ring of the at least one rolling bearing, so as to cool the inner ring.

According to one embodiment, the cooling channel forms a groove on the outer surface of the rotary shaft. In this case, the inner ring may be configured to externally radially close the groove formed by the cooling channel.

According to one embodiment, the at least one cooling channel has a cross-section of constant shape along said at least one cooling channel, in particular rectangular, or partially or completely circular.

Generally speaking, the cooling channels can have any cross-sectional shape that can be obtained by an industrial machining process along an axis, for example, by forming grooves or streaks by knurling.

This makes machining the cooling channels on the outer surface of the rotary shaft easier.

According to one embodiment, the cooling channels have a square cross-sectional shape, for example, 0.7 mm on each side.

Thus, the use of cooling channels with a relatively small cross-sectional area makes it possible to operate at low Reynolds numbers and optimize pressure drops and heat exchange.

According to one embodiment, the at least one cooling channel extends axially in a straight line between the fluid inlet and the fluid outlet where the cooling fluid exits the cooling channel.

According to one embodiment, the at least one cooling channel extends substantially parallel to the axis of rotation.

In this way, it is possible to optimize the cooling fluid flow rate in the cooling channels and the pressure drop.

According to one embodiment, the at least one cooling channel has a length, measured axially, between the fluid inlet and the fluid outlet, greater than a width of the inner ring(s) measured axially.

According to one embodiment, the rotary shaft comprises an annular outlet groove, arranged on the side opposite the fluid receiving portion relative to the at least one rolling bearing, said annular outlet groove forming the fluid outlet.

According to one embodiment, the rotary shaft device comprises a seal, for example a dynamic seal, disposed on the side opposite the flow portion relative to the fluid outlet.

According to one embodiment, the housing comprises a cylindrical lateral wall and a distal end wall extending from the cylindrical lateral wall radially inward of the cylindrical lateral wall, said distal end wall defining, with the pressurization member, an access conduit opening into the pressurization reservoir at an access opening, said access conduit being configured to allow the introduction of the cooling fluid into the pressurization reservoir.

Advantageously, the presence of the access conduit allows the introduction of the cooling fluid into the pressurization reservoir. For example, but not limited to, the access conduit allows the cooling fluid to be introduced axially into the pressurization reservoir. Thus, it is not necessary to pressurize the cooling fluid, for example, using a pump, to overcome artificial gravity generated, for example, by centrifugal force. Before flowing into the pressurization reservoir, the cooling fluid can flow radially through the access conduit, from the outside to the inside, between the distal end wall and the pressurization member.

According to one embodiment, the housing comprises a cylindrical skirt extending parallel to the internally cylindrical lateral wall between the pressurization member and the rotary shaft, the access conduit then being defined between the cylindrical skirt and the pressurization member.

According to one embodiment, the cylindrical lateral wall, the distal end wall, and the cylindrical skirt internally delimit between them a volume configured to retain a quantity of cooling fluid, so as to form a cooling fluid bath intended to be pressurized by the pressurization member when it is rotated.

According to one embodiment, the housing comprises a second cylindrical lateral wall, parallel to the cylindrical lateral wall and secured to the distal end wall so as to form an additional volume for receiving the cooling fluid. For example, the second cylindrical lateral wall is arranged radially on the side opposite the pressurization member relative to the cylindrical lateral wall.

According to one embodiment, the cylindrical lateral wall is provided with an inlet opening configured to allow a fluid communication between a volume inside the cylindrical lateral wall and a volume outside the cylindrical lateral wall.

According to one embodiment, the cylindrical lateral wall, the distal end wall, the second cylindrical lateral wall, and the cylindrical skirt form a single-piece part, having for example a section in a plane perpendicular to the E-shaped axis of rotation.

According to one embodiment, the cylindrical lateral wall and the distal end wall internally form between them a volume configured to retain a quantity of cooling fluid, so as to form a cooling fluid bath in which at least a portion of the fluid receiving portion is immersed.

According to one embodiment, the cylindrical lateral wall, the distal end wall, and the second cylindrical lateral wall form a single piece, for example having a U-shaped section in a plane perpendicular to the axis of rotation.

Advantageously, the injection of cooling fluid at the pressurization member eliminates the need for dynamic, labyrinth, or air seals.

According to one embodiment, the cylindrical lateral wall of the housing comprises a discharge orifice passing through the cylindrical lateral wall to allow the cooling fluid to be discharged outside the housing.

According to one embodiment, the housing comprises a closure system configured to at least partially close the discharge orifice, so as to limit or block the passage of the cooling fluid through the cylindrical lateral wall of the housing.

According to one embodiment, the cooling fluid is a functional fluid having intrinsic characteristics that give it the ability to perform a cooling function and/or a lubrication function.

According to one embodiment, the cooling fluid comprises a lubrication oil, preferably having a viscosity comprised between 1 cSt and 45 cSt, and more particularly equal to 15 cSt, at temperatures between 30 and 80° C., and more particularly between 40° C. and 50° C. 1 cSt being equal to 10⁻⁶ m²/s.

In this way, at a given rotational speed, it is possible to adjust the oil flow rate passing through a cooling channel having a given dimension.

According to one embodiment, the at least one rolling bearing comprises: an inner ring secured to the outer surface of the rotary shaft; an outer ring radially offset from the inner ring and secured to the housing; the rolling elements interposed between said inner and outer rings and mounted to roll on both the inner and outer rings; and a cage placed between said inner and outer rings, maintaining a regular space between the rolling elements.

According to one embodiment, the rolling elements are mounted to roll on tracks of the two inner rings.

According to one embodiment, the inner ring has a contact face facing the rotary shaft, said contact face being in contact with the rotary shaft over at least 70% of its total surface area. According to this embodiment, the contact between the contact face and the rotary shaft is uniformly distributed.

According to one embodiment, the at least one rolling bearing is fitted onto the rotary shaft at the flow portion.

According to one embodiment, the rolling elements are balls in the case of a ball bearing, rollers in the case of a roller bearing, or needles in the case of a needle bearing.

According to one embodiment, the at least one cooling channel is open radially towards the inner ring of the at least one rolling bearing, such that the cooling fluid passing through at least one cooling channel is in direct contact with the inner ring.

According to one embodiment, the cooling channels are distributed radially uniformly over the rotary shaft, such that the contact face of the inner ring remains in contact with the rotary shaft over at least 70% of its total surface area.

Advantageously, providing a spacing ratio between two cooling channels and a cooling channel width comprised between 2 and 10 allows good cylindricity of the inner ring and avoids disrupting the proper operation of the rolling bearing.

According to one embodiment, the rotary shaft is an extension shaft or a transmission shaft of an aircraft and driving an accessory gearbox such as pumps.

The purpose of the invention can also be achieved by implementing a turbocharger capable of compressing a refrigerant, said turbocharger comprising a rotary shaft device as described above.

According to one embodiment, the cooling fluid comprises the refrigerant.

The purpose of the invention can also be achieved by implementing a rotating electrical machine capable of propelling a road or rail vehicle, said machine comprising a rotary shaft device as described above.

According to one embodiment, the rotating electrical machine is an electric motor, an alternator, a generator, or an alternator-starter.

The purpose of the invention can also be achieved by implementing a spindle or electro-spindle capable of equipping a machine-tool, said spindle or electro-spindle comprising a rotary shaft device as described above.

The purpose of the invention can also be achieved by implementing an active or passive magnetic bearing for supporting a rotary shaft or assembly, said bearing comprising a rotary shaft device as described above.

The purpose of the invention may also be achieved by implementing a high-speed reducer or multiplier for industrial, automotive, railway, or aeronautical applications, for transmitting movement, torque, or energy, said reducer or multiplier comprising at least one rotary shaft device as described above.

The purpose of the invention may also be achieved by implementing a gas or steam turbine for energy production, propulsion, or the generation of any movement, said turbine comprising a rotary shaft device as described above.

The purpose of the invention may also be achieved by implementing a pump for circulating fluid, said pump comprising a rotary shaft device as described above.

The purpose of the invention may also be achieved by implementing a fan or blower for propelling a gas, said fan or blower comprising a rotary shaft device as described above.

The purpose of the invention can also be achieved by implementing a centrifuge, decanter, or mixer for the chemical or food industry, or the production of ore, powder, glass wool, or rock wool, said centrifuge, decanter, or mixer comprising a rotary shaft device as described above.

The purpose of the invention can also be achieved by implementing a flywheel capable of functioning as a kinetic energy accumulator, said flywheel comprising a rotary shaft device as described above.

The purpose of the invention can also be achieved by implementing an aircraft propulsion system, such as a turboprop or turbojet engine, comprising at least one rotary shaft device as described above.

The purpose of the invention can also be achieved by implementing a test bench with high-speed rotary shaft(s) or member(s) and with or without the presence of a heating source, said test bench comprising at least one rotary shaft device as described above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective view showing a cross-sectional view of a rotary shaft device according to a particular embodiment of the invention.

FIG. 2 is a schematic perspective view showing a cross-sectional view of a pressurization member according to a particular embodiment of the invention.

FIG. 3 is a schematic perspective view showing a cross-sectional view of a rotary shaft device according to another particular embodiment of the invention.

FIG. 4 is a schematic perspective view showing a cross-sectional view of a rotary shaft according to a particular embodiment of the invention.

FIG. 5 is a schematic perspective view showing a cross-sectional view of a pressurization member according to a particular embodiment of the invention.

FIG. 6 is a schematic perspective view showing a cross-sectional view of the pressurization member, the housing, and the rotary shaft according to a particular embodiment of the invention.

FIG. 7 is a schematic perspective view showing a cross-sectional view of the pressurization member, the housing, and the rotary shaft according to a particular embodiment of the invention.

FIG. 8 is a schematic view of the Stribeck curve, showing the temperature of a rolling bearing and friction losses as a function of the quantity and flow rate of an oil.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the figures and in the remainder of the description, the same references represent identical or similar elements. Furthermore, the various elements are not shown to scale so as to enhance clarity of the figures. Moreover, the various embodiments and variants are not mutually exclusive and can be combined with each other.

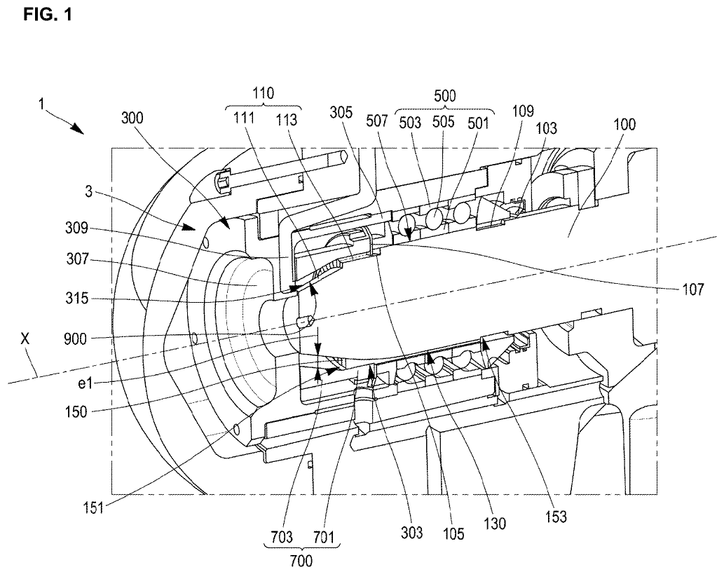

As illustrated in FIGS. 1 to 7, the invention concerns a rotary shaft device 3. The invention also concerns a turbocharger 1 capable of compressing a refrigerant comprising such a rotary shaft device 3. The rotary shaft device 3 can also be adapted to various rotating machines with rotary shafts, particularly, but not exclusively, if they rotate at high speed.

The rotary shaft device 3 firstly comprises a rotary shaft 100 surrounded by a housing 300. The rotary shaft 100 is mounted to rotate relative to the housing 300 about an axis of rotation designated “X”. The rotary shaft 100 has a geometry of revolution about said axis of rotation X. The orientation of the axis of rotation X is not fixed in space and depends on the orientation that the user wishes to give to the rotary shaft device 3. It may, for example, be oriented along a vertical axis for machines with a vertical axis, but such an orientation is not limiting. The rotary shaft 100 comprises a main body comprising a fluid receiving portion 110 generally located on the periphery of the rotary shaft and which is, for example, arranged at one end or in a stepped area of the main body of the rotary shaft 100, and at which a cooling fluid can be received. In the particular case of turbochargers, it may be provided that the cooling fluid comprises or consists of the refrigerant to be compressed. This cooling fluid is intended to cool the rotary shaft device when the latter is rotated about the axis of rotation X. The cooling fluid may thus comprise a lubrication oil, preferably having a viscosity comprised between 1 cSt and 45 cSt, and more particularly equal to 15 cSt, at temperatures between 30 and 80° C., and more particularly between 40° C. and 50° C. The cooling fluid may comprise water.

The rotary shaft device 3 then comprises at least one rolling bearing 500 comprising rolling elements 505, for example arranged between the rotary shaft 100 and the housing 300, and being configured to allow the rotary shaft 100 to be mounted in rotation relative to the housing 300. According to another variant shown in FIG. 5, the at least one rolling bearing 500 may be arranged between a pressurization member 700, which will be described later, and the housing 300. In general, and as illustrated in FIG. 1, the at least one rolling bearing 500 may comprise: an inner ring 501 secured to an outer surface 303 of the rotary shaft 100; an outer ring 503 radially offset relative to the inner ring 501 and secured to the housing 300; the rolling elements 505 interposed between said inner ring 501 and outer ring 503 and mounted on a rolling bearing 500 on both the inner ring 501 and outer ring 503; and a cage placed between said inner ring 501 and outer ring 503, and maintaining a regular space between the rolling elements 505.

Generally, the rolling elements 505 are balls in the case of a ball bearing, rollers in the case of a roller bearing, or needles in the case of a needle bearing. The inner ring 501 may have a contact face 507 facing the rotary shaft 100. This contact face 507 may then be in contact with the rotary shaft 100 over at least 70% of its total surface area, and preferably with a regular peripheral distribution. Thus, the contact between the contact face 507 and the rotary shaft 100 is uniformly distributed.

Advantageously, the fluid receiving portion 110 may be directly adjacent to a flow portion 130 of the rotary shaft 100 at which the at least one bearing 500 is arranged. Thus, it is not necessary to provide holes, channels, or any other element for bringing the cooling fluid to the fluid receiving portion. For this purpose, it may be provided that the fluid receiving portion 110 is arranged on a portion of the rotary shaft 100 that has a diameter strictly smaller than an inner diameter of the at least one rolling bearing 500, and in particular the inner diameter of the smallest of the rolling bearings 500 when the rotary shaft device 3 comprises several rolling bearings. In this manner, it is possible for the at least one rolling bearing 500 to be fitted onto the rotary shaft 100 at the flow portion 130.

The rotary shaft device 3 also comprises a pressurization member 700 connected to or belonging to the rotary shaft 100 and secured in rotation to the rotary shaft 100. Generally speaking, and as shown in the figures, the pressurization member 700 is a separate part from the body of the rotary shaft 100 and may be secured to the rotary shaft 100. However, such a construction is not limiting, and it is also possible for the pressurization member 700 and the body of the rotary shaft 100 to form a single-piece part.

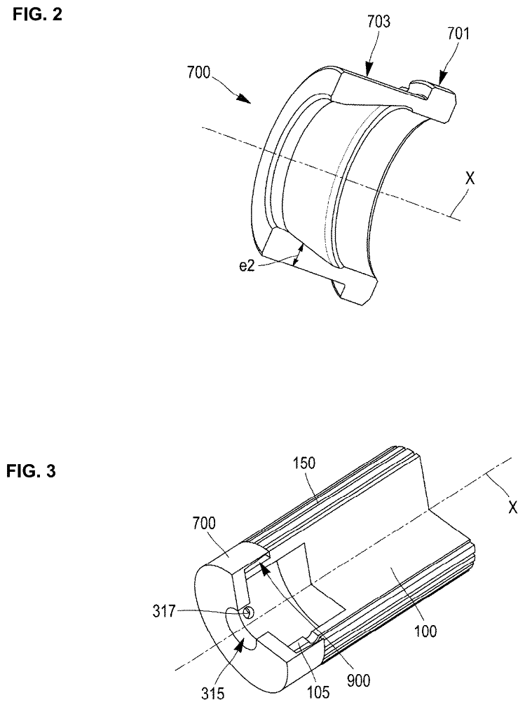

The pressurization member 700 is radially disposed between the main body of the rotary shaft 100 and the housing 300, and axially positioned at the fluid receiving portion 110 of the main body of the rotary shaft 100. Generally, the pressurization member 700 is radially disposed at the periphery of the rotary shaft 100. FIG. 2 shows a non-limiting variant of such a pressurization member 700. The pressurization member 700 is generally offset axially along the axis of rotation X relative to said at least one rolling bearing 500. The pressurization member 700 and the main body of the rotary shaft 100 define between them a pressurization reservoir 900 configured to receive a volume of the cooling fluid. As indicated previously, it is possible for the main body of the rotary shaft 100 and the pressurization member 700 to form an integral assembly, for example at the periphery of the shaft.

According to a variant shown in FIG. 3, the rotary shaft 100 comprises a collection groove 105 disposed between the main body of the rotary shaft 100 and the housing 3. Moreover, and as shown in FIG. 3, the pressurization member 700 may cover the collection groove 105 to define the pressurization reservoir 900. In the case where the rotary shaft 100 and the pressurization member 700 form a single integral part, the collection groove 105 may correspond to a groove hollowed out in the material constituting said integral part. Regardless of the considered variant, the cooling fluid can enter the pressurization reservoir via an access opening 315. In the embodiment of FIG. 3, the access opening 315 is provided through a wall of the pressurization member 700 and communicates fluidically with the pressurization reservoir 900 via collection orifices 317.

According to a variant not shown, the pressurization member 700 may comprise collection channels, whether or not attached to the main body of the rotary shaft 100 and extending radially relative to the axis of rotation X and opening into the pressurization reservoir 900.

Referring again to FIG. 2, the pressurization member 700 may comprise a proximal pressurization portion 701 configured to cover the rotary shaft 100, and a distal pressurization portion 703 which extends from the proximal pressurization portion 701 along the axis of rotation X, in a direction moving away from said at least one rolling bearing 500. Advantageously, the distal pressurization portion 703 and the proximal pressurization portion 701 may be formed integrally within an integral part forming the pressurization member 700. The distal pressurization portion 703 may have a geometry of revolution about the axis of rotation, converging up to the proximal pressurization portion 701. For this, it may be provided that the distal pressurization portion 703 has a pressurization member thickness e2 measured radially relative to the axis of rotation X which progressively decreases when axially approaching the proximal pressurization portion 701. Alternatively, the distal pressurization portion 703 may have a thickness of the pressurization member e2 measured radially relative to the axis of rotation X which is constant, and has an inner diameter measured radially relative to the axis of rotation X which progressively decreases as it axially approaches the proximal pressurization portion 701.

The rotary shaft device 3 further comprises at least one cooling channel 150 radially disposed between the main body of the rotary shaft 100 and the at least one rolling bearing 500. In general, the rotary shaft device 3 comprises a plurality of cooling channels 150. In the remainder of the description, reference will therefore be made to “cooling channels 150”, but it is understood that the embodiments presented may be implemented with a single cooling channel 150. In general, the rotary shaft device 3 comprises at least two and preferably at least four cooling channels 150. These cooling channels 150 are radially distributed uniformly over the rotary shaft 100. In this way, the cooling function of the entire rotary shaft device 3 is improved.

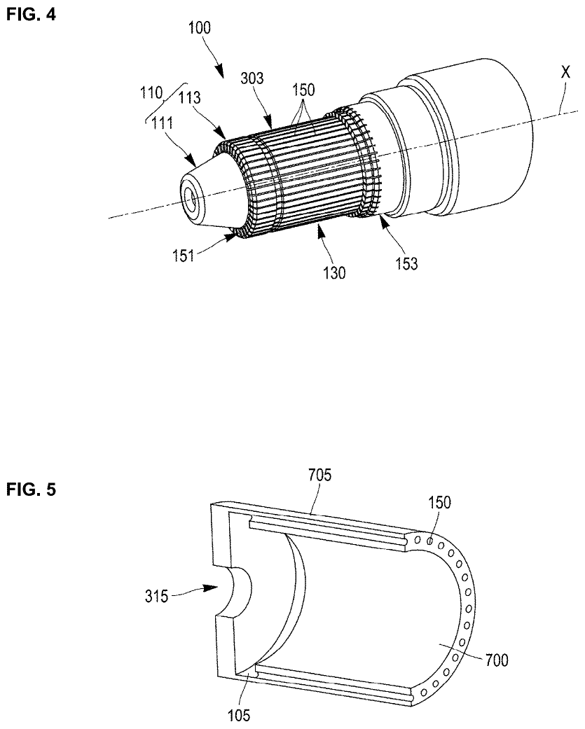

As illustrated in FIG. 4, the rotary shaft 100 may delimit at least one cooling channel 150. For example, said at least one cooling channel 150 may be provided on an outer surface 303 of the rotary shaft 100. However, such a variant is not limiting, and it is also possible for at least one cooling channel 150 to be provided inside the rotary shaft 100, for example, in the main body of the cooling shaft.

According to another variant shown in FIG. 5, the cooling channels are arranged in the main body of the pressurization member 700. The pressurization member 700 may, for example, comprise a cylindrical axial skirt 705 extending axially about the axis of rotation X, within which are present: a collection and pressurization groove 105 directly adjacent to the axial cooling channels 150. It is then possible for said cylindrical axial skirt 705 to cover, as an added part, the main body of the rotary shaft 100 at the flow portion 130.

The cooling channels 150 extend between a fluid inlet 151 and a fluid outlet 153, and have at least one component along the axis of rotation X; they are moreover in fluid communication at the fluid inlet 151, with the pressurization reservoir 900. The cooling channels 150 are configured to ensure heat transfer between the rotary shaft 100, said at least one rolling bearing 500, and the cooling fluid, when the cooling fluid circulates in the cooling channels 150 from the pressurization reservoir 900. It is therefore understood that the cooling channels 150 ensure fluid communication between the pressurization reservoir 900 and the fluid outlet 153. Moreover, it may be provided that the at least one cooling channel 150 is fluidically isolated from the rolling elements 505 of the at least one rolling bearing 500. The term “fluidically isolated” means that the quantity of fluid used for lubrication, reaching the rolling elements 505 of the at least one rolling bearing 500 from the cooling channels 150 or the pressurization reservoir, or even from a separate device, can be controlled via appropriate sizing or device, independently of the flow supplying the pressurization reservoir and the cooling channels 150. Thus, it is possible to cool the rotary shaft device 3, limiting the risk of shearing of the cooling fluid in the event that it reaches the rolling elements 505 of the at least one rolling bearing 500.

Depending on the adopted embodiment, the technical characteristics of the cooling channels 150 may vary. However, as indicated previously, it is advantageous to provide a number of cooling channels 150 greater than or equal to two. Indeed, the use of a large number of cooling channels 150 makes it possible to increase the flow rate of cooling fluid used to cool the entire rotary shaft device 3, and in particular the rotary shaft 100 and the at least one rolling bearing 500. It is, however, possible to have one or more cooling channels 150 forming a labyrinth on the outer surface 303 of the rotary shaft 100 to perform the heat exchange function. In the variant illustrated in FIG. 4, each cooling channel 150 forms a groove cut into the outer surface 303 of the rotary shaft. The cooling channels 150 may be oriented axially relative to the rotation axis X, and in a helical or rectilinear manner between the fluid inlet 151 and the fluid outlet 153 where the cooling fluid exits the cooling channel 150. The cooling channels 150 may thus extend substantially parallel to the rotation axis X. In this way, it is possible to optimize the cooling fluid flow rate in the cooling channels 150 and the pressure drop.

Generally speaking, the configuration of each cooling channel 150 depends at least in part on: the thermal conductivity of the cooling fluid and the materials constituting the rotary shaft 100; the Prandlt number of the cooling fluid; and the cooling fluid flow rate corresponding to a thermal power to be evacuated.

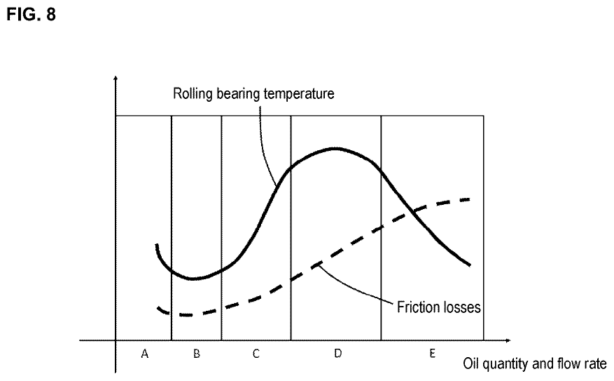

In order to facilitate the machining of the cooling channels 150, it may be provided that the cooling channels 150 have a cross-section of constant shape along said at least one cooling channel 150, in particular a partially or completely circular shape, or a rectangular shape. More specifically, the cooling channels 150 may have a cross-section of a square shape, for example, 0.7 mm on each side. Thus, the use of cooling channels 150 having a relatively small cross-section makes it possible to operate at a low Reynolds number and to optimize pressure drops and heat exchange. The number of cooling channels 150 and the width of the cooling channels 150 are generally a function of the thermal power to be removed and the characteristics of the cooling fluid (thermal conductivity, viscosity, heat capacity). These parameters influence the occupancy rate of the cooling channels 150 on the outer surface 303. Generally speaking, the cooling channels 150 may have any cross-sectional shape that can be obtained by an industrial machining process along an axis, for example by forming grooves or ridges by knurling. FIG. 8, called the Stribeck curve, known to those skilled in the art, illustrates in particular the temperature of a bearing and the friction losses as a function of the quantity and flow rate of cooling fluid. The rotary shaft device 3 according to the invention may in particular comprise cooling channels having a fluid communication with the rolling elements 505 of the at least one bearing 500 that is zero or very low. Thus, the quantity or flow rate of cooling fluid reaching the rolling elements 505 is very low. The bearing 500 can also be supplied using a separate system that allows the dosage to be adjusted to a minimum flow rate value for lubrication purposes only and not for heat removal. The rotary shaft device 3 according to the invention can therefore have an operating point on the Seebeck curve of FIG. 8, which is located in zone A or zone B depending on the considered embodiments, while benefiting from the advantages of heat dissipation in zone E. Thus, the temperature of the at least one rolling bearing 500 and friction losses are limited.

According to one embodiment, the occupancy rate of the outer surface 303 by the cooling channels 150 is comprised between 10% and 30%. In other words, an apparent surface area of the channels represents 10% to 30% of the outer surface area of the rotary shaft 100. Such an occupancy rate is selected to ensure sufficient Hertz pressure to ensure the clamping of the ring of at least one rolling bearing 500 on the rotary shaft 100. Moreover, it is advantageous to provide a ratio of a spacing between two cooling channels 150 and a width of a cooling channel 150 comprised between 2 and 10. In this way, it is possible to be protected against a deformation of the raceway of the inner ring 501 at the cooling channels 150.

Synergistically, the use of a large number of cooling channels 150 in the form of fine grooves makes it possible to guarantee cooling with a high flow rate, while limiting the pressure drop experienced by the cooling fluid, and to ensure temperature uniformity. Moreover, the use of a large number of cooling channels 150 allows increasing the exchange surface area wetted by the cooling fluid and therefore increases the evacuated hot power.

According to one embodiment, each cooling channel 150 has a channel depth measured radially relative to the rotation axis X, which is strictly less than a storage height of the pressurization reservoir 900 measured radially relative to the rotation axis X. In this way, it is possible to place the cooling fluid under overpressure relative to ambient pressure at the fluid inlet 151 when the cooling fluid is subjected to centrifugal force caused by the rotational movement of the rotary shaft 100 about the rotation axis X. Generally, said overpressure may be greater than 1.5 bar, and more particularly between 2 bar and 10 bar. In particular, in the case where the rotary shaft 100 has a diameter substantially equal to 70 mm, and in the case where the rotation speed is substantially equal to 12,000 rpm, said overpressure may be equal to 5 bars. By substantially equal, it is meant a value equal to within 10%.

According to the non-limiting variant shown in FIG. 4, the fluid receiving portion 110 comprises a first part 111 without a cooling channel 150. The presence of such a first part 111 is not, however, limiting; it is also possible for such a first part 111 to be absent. This first part 111 of the fluid receiving portion 110 may have a frustoconical shape and may be arranged opposite the distal pressurization portion 703. Advantageously, the use of a fluid receiving portion 110 having at least one part preferably having a frustoconical shape makes it possible to define a pressurization reservoir 900 which generates a volume of cooling fluid in the form of a fluid ring when the cooling fluid is rotated. Thus, it is possible to generate a hydrostatic overpressure at the fluid inlet 151. This hydrostatic overpressure depends in particular on: a height of cooling fluid measured radially in the pressurization reservoir, the outer diameter of the grooves, and the rotational speed of the rotary shaft 100. Alternatively, the first part 111 of the fluid receiving portion 110 may have a hemispherical or stepped cylindrical shape. Advantageously, the first part 111 facilitates the uniform rotation of the cooling fluid. Indeed, the synchronous rotation of the rotary shaft 100 with the cooling fluid ensures efficient introduction of the cooling fluid into the cooling channels 150. The first part 111 allows also preventing the occurrence of swirl or rebound phenomena leading to poor penetration of the cooling fluid into the cooling channels 150.

In the case where the pressurization member 700 and the rotary shaft 100 have generally complementary shapes, an air gap e1 between the pressurization member 700 and the rotary shaft 100, measured along an axis perpendicular to a first outer surface of the first part 111, may be axially constant along the first part 111. Thus, the pressurization reservoir 900 may have a hollow frustoconical shape, the hollow of which is formed at least partially by the first part 111 of the fluid receiving portion 110. Thus, and advantageously, the shape of the pressurization reservoir 900 both allows for overflow of the cooling fluid in the event that too much cooling fluid is injected, and prevents cooling fluid backflow or a swirl effect, particularly during a rapid increase in the rotational speed of the rotary shaft 100. Synergistically, the frustoconical shape of the pressurization reservoir 900 allows the cooling fluid to flow to the cooling channels 150, which makes it possible to bring the cooling fluid to the inlet of the cooling channels 150 for cooling fluid flow rates that are too low to allow the formation of a ring of cooling fluid.

The fluid receiving portion 110 may also comprise a second part 113 which extends, along the rotation axis X, from the first part 111 of the fluid receiving portion 110, in a direction approaching said at least one rolling bearing 500. The first part 111 of the fluid receiving portion 110 and the second part 113 of the fluid receiving portion 110 may be formed integrally within an integral part forming the fluid receiving portion 110. In contrast to the first part 111, the second part 113 of the fluid receiving portion comprises cooling channels 150. In other words, at least one part of the outer surface 303 of the rotary shaft 100 is included in the second part 113 of the fluid receiving portion 110, such that the cooling channels 150 extend from the second part 113 of the fluid receiving portion 110 to the flow portion 130 and over all or part of the flow portion 130. According to this embodiment, the pressurization member 700 may comprise a proximal pressurization portion 701 configured to cover the rotary shaft 100 on said second part 113 of the fluid receiving portion 110, so as to externally close radially the at least one cooling channel 150. For example, the proximal pressurization portion 701 may have a cylindrical shape.

The second part 113 of the fluid receiving portion 110 may be at least partially threaded, so as to allow the pressurization member 700 to be screwed onto the proximal pressurization portion 701. Similarly, the proximal pressurization portion 701 may be at least partially threaded, so as to allow the pressurization member 700 to be screwed onto the second part 113 of the fluid receiving portion 110. Alternatively, the proximal pressurization portion 701 may be radially adjusted so that it can be fitted or glued. Thus, the pressurization member 700 can be attached to the second part 113 of the fluid receiving portion 110.

According to a variant not shown, at least one element, selected from the group comprising the pressurization member 700 and the first part 111 of the fluid receiving portion 110, comprises orientation fins configured to direct the cooling fluid toward the fluid inlet 151 in the manner of a centrifugal pump. These orientation fins can be arranged on an outer surface of the first part 111 of the fluid receiving portion 110, and can have a helical shape.

As illustrated in FIG. 1, the inner ring 501 of the rolling bearings 500 is rotatably secured to the rotary shaft 100. In this case, the inner ring 501 may at least partially cover the cooling channels 150. It is therefore clearly understood that the cooling channel 150 is arranged under the inner ring 501 of the at least one rolling bearing 500, so as to cool the inner ring 501. In particular, if the cooling channels 150 form grooves on the outer surface 303 of the rotary shaft 100, then the inner ring 501 may be configured to externally radially close the groove formed by the cooling channel 150. In other words, the at least one cooling channel 150 is open radially towards the inner ring 501, so that the cooling fluid passing through at least one cooling channel 150 is in direct contact with the inner ring 501.

In order to ensure improved cooling, the cooling channels 150 may be distributed radially uniformly on the rotary shaft 100, so that the contact face 507 of the inner ring 501 remains in contact with the rotary shaft 100 over at least 70% of its total surface area. Advantageously, providing a ratio of a spacing between two cooling channels 150 and a width of a cooling channel 150 comprised between 2 and 10 ensures good cylindricity of the inner ring 501 and avoids disrupting the proper operation of the rolling bearing 500. Finally, it may be provided that the at least one cooling channel 150 has a length, measured axially, between the fluid inlet 151 and the fluid outlet 153 greater than a width of the inner ring(s) 501, measured axially. In this way, it is possible to place other elements between the fluid inlet 151 and the fluid outlet 153. In particular, these elements may comprise a seal 103, for example a dynamic seal, arranged on the side opposite the flow portion 130 with respect to the fluid outlet 153. Furthermore, the rotary shaft 100 may comprise an annular outlet groove 109, arranged on the side opposite the fluid receiving portion 110 relative to the at least one rolling bearing 500. This annular outlet groove 109 forms the fluid outlet 153.

Generally speaking, to ensure optimal operation of the at least one rolling bearing 500, it is preferable for the rolling elements 505 to be lubricated. Thus, according to one embodiment, it may be provided that a part of the cooling fluid is used to lubricate the rolling elements 505. In this case, the rotary shaft device 3 may comprise lubrication means configured to allow the passage of a part of the cooling fluid to the rolling elements 505. In particular, the flow means may be configured to allow a flow rate of around 1 mm per minute of cooling fluid to the rolling elements 505.

According to a first alternative, it may be provided that at least one element selected from the pressurization member 700, the inner ring 501, and an interface part 38 has a sufficiently coarse surface finish, or sufficient surface porosity to allow the passage of the cooling fluid under the effect of the centrifugal force generated by the rotary shaft 100 in movement. In particular, this coarse surface finish, or this sufficient surface porosity, may be selected between two parts in axial contact, such as, for example, between two inner rings if the rotary shaft device 3 comprises several rolling bearings 500. According to one embodiment, the term “sufficiently coarse surface finish” means a surface finish having a roughness greater than Ra=3.2 μm, for example a roughness comprised between Ra=3.2 μm and Ra=6.4 μm, and more particularly a roughness substantially equal to Ra=3.2 μm.

According to a second alternative, a microchannel may be provided in the main body of said at least one element selected from the pressurization member 700, the inner ring 501, and the interface part 38. In this case, said microchannel may be provided radially from one or more of the cooling channels 150, or from the pressurization reservoir 900, towards the rolling elements 505. It has been found that a larger cross-sectional dimension comprised between 0.05 mm and 0.1 mm makes it possible to obtain sufficient lubrication, while limiting the risks of overheating due to heating of the cooling fluid.

The arrangements described above make it possible to propose a rotary shaft device 3 capable of ensuring the cooling of at least one rolling bearing 500, the rotary shaft 100, and any seals present in the rotary shaft device 3.

As illustrated in FIGS. 1, 6, and 7, the housing 300 may comprise a cylindrical lateral wall 305 and a distal end wall 307 extending from the cylindrical lateral wall 305 radially inward of the cylindrical lateral wall 305. This distal end wall 307 may then define, with the pressurization member 700, an access conduit 309 opening into the pressurization reservoir 900 at an access opening 315, said access conduit 309 being configured to allow the introduction of the cooling fluid into the pressurization reservoir 900.

Advantageously, the presence of the access conduit 309 as shown in FIG. 1 makes it possible to introduce the cooling fluid axially into the pressurization reservoir 900. Thus, it is not necessary to pressurize the cooling fluid, for example by means of a pump, to overcome artificial gravities, for example generated by a centrifugal force.

Before flowing axially into the pressurization reservoir 900, the cooling fluid may first flow radially through the access conduit 309, from the outside to the inside, between the distal end wall 307 and the pressurization member 700.

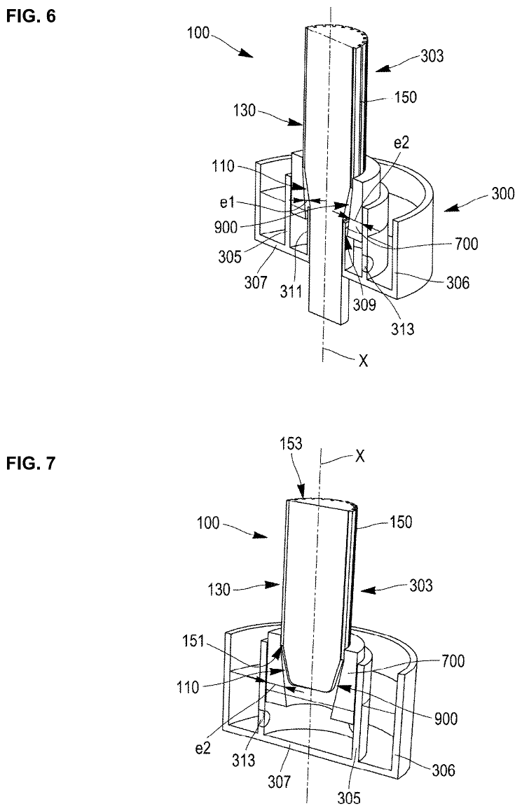

According to a second variant, shown in FIG. 6, the housing 300 comprises a cylindrical skirt 311 extending parallel to the cylindrical lateral wall 305 internally between the pressurization member 700 and the rotary shaft 100, the access conduit 309 then being defined between the cylindrical skirt 311 and the pressurization member 700. According to this second variant, the cylindrical lateral wall 305, the distal end wall 307, and the cylindrical skirt 311 internally delimit a volume configured to retain a quantity of cooling fluid, so as to form a cooling fluid bath intended to be pressurized by the pressurization member 700 when it is rotated. Additionally, the housing 300 may comprise a second cylindrical lateral wall 306, parallel to the cylindrical lateral wall 305 and secured to the distal end wall 307 so as to form an additional volume for receiving cooling fluid. This second cylindrical lateral wall 306 may, for example, be arranged radially on the side opposite the pressurization member 700 relative to the cylindrical lateral wall 305. Said cylindrical lateral wall 305 may then be provided with an inlet opening 313 to allow a fluid communication between a volume inside the cylindrical lateral wall 305 and a volume outside the cylindrical lateral wall 305. The cylindrical lateral wall 305, the distal end wall 307, the second cylindrical lateral wall 306, and the cylindrical skirt 311 form a single-piece part, having, for example, an E-shaped section in a plane perpendicular to the rotation axis X.

According to a third variant shown in FIG. 7, the cylindrical lateral wall 305 and the distal end wall 307 internally form between them a volume configured to retain a quantity of cooling fluid, so as to form a bath of cooling fluid in which at least one part of the fluid receiving portion 110 is immersed. The housing 300 may, as in the previous variant, comprise a second cylindrical lateral wall 306, parallel to the cylindrical lateral wall 305 and secured to the distal end wall 307 so as to form an additional volume for receiving cooling fluid, the cylindrical lateral wall 305 then being provided with an inlet opening 313 to allow a fluid communication between a volume inside the cylindrical lateral wall 305 and a volume outside the cylindrical lateral wall 305. The cylindrical lateral wall 305, the distal end wall 307, and the second cylindrical lateral wall 306 form a single piece part, for example having a U-shaped section in a plane perpendicular to the rotation axis X. Advantageously, the injection of cooling fluid at the pressurization member 700 eliminates the need for dynamic labyrinth, or air seals. Whether the housing 300 is configured to form a cooling fluid bath or not, the cylindrical lateral wall 305 of the housing 300 may comprise a discharge orifice 311 passing through the cylindrical lateral wall 305 so as to allow the cooling fluid to be discharged outside the housing 300. In this case, the housing 300 may comprise a closure system configured to at least partially close the discharge orifice 311, so as to limit or block the passage of the cooling fluid through the cylindrical lateral wall 305 of the housing 300.

All of the arrangements described above make it possible to propose a rotary shaft device 3 in which the pressurization reservoir 900 places the cooling fluid under overpressure relative to the ambient pressure, at the fluid inlet 151, when the cooling fluid is subjected to a centrifugal force caused by the rotational movement of the rotary shaft 100 about the rotation axis X.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A rotary shaft device comprising:
a housing;
a rotary shaft surrounded by the housing, rotatably mounted relative to the housing about an axis of rotation, and having a geometry of revolution about said axis of rotation, the rotary shaft comprising a main body comprising a fluid receiving portion;
at least one rolling bearing comprising rolling elements, and ensuring the rotatably mounting of the rotary shaft relative to the housing;
a pressurization member belonging to the rotary shaft, and secured in rotation to the main body of the rotary shaft, the pressurization member being radially disposed between the main body of the rotary shaft and the housing and axially positioned at the fluid receiving portion of the main body of the rotary shaft, the pressurization member and the main body of the rotary shaft defining between them a pressurization reservoir configured to receive a volume of a cooling fluid; and
at least one cooling channel radially arranged between the main body of the rotary shaft and the at least one rolling bearing, and extending between a fluid inlet and a fluid outlet, the at least one cooling channel having at least one component along the axis of rotation, and being in fluid communication, at the fluid inlet, with the pressurization reservoir, the at least one cooling channel being configured to provide heat transfer between the rotary shaft, the at least one rolling bearing, and the cooling fluid, when the cooling fluid flows along the at least one cooling channel from the pressurization reservoir.

2. The rotary shaft device according to claim 1, wherein the rotary shaft delimits the at least one cooling channel.

3. The rotary shaft device according to claim 1, wherein the pressurization reservoir is configured to place the cooling fluid under overpressure relative to an ambient pressure, at the fluid inlet, when the cooling fluid is subjected to a centrifugal force caused by a rotational movement of the rotary shaft about the axis of rotation.

4. The rotary shaft device according to claim 2, wherein the fluid receiving portion comprises a first part devoid of a cooling channel, the first part of the fluid receiving portion preferably having a frustoconical shape.

5. The rotary shaft device according to claim 4, wherein at least one element, selected from the group comprising the pressurization member and the first part of the fluid receiving portion, comprises orientation fins configured to direct the cooling fluid toward the fluid inlet.

6. The rotary shaft device according to claim 1, wherein the at least one cooling channel is provided on an outer surface of the rotary shaft.

7. The rotary shaft device according to claim 6, wherein the pressurization member comprises a proximal pressurization portion configured to cover the rotary shaft on a second part of the fluid receiving portion, so as to externally close radially the at least one cooling channel.

8. The rotary shaft device according to claim 7, wherein the pressurization member comprises a distal pressurization portion, distinct from the proximal pressurization portion, and having a geometry of revolution about the axis of rotation, converging up to the proximal pressurization portion.

9. The rotary shaft device according to claim 8, wherein the distal pressurization portion has a pressurization member thickness measured radially relative to the axis of rotation which progressively decreases as it axially approaches the proximal pressurization portion.

10. The rotary shaft device according to claim 1, wherein the at least one cooling channel has a cross-section of constant shape along the at least one cooling channel, in particular of rectangular shape.

11. The rotary shaft device according to claim 1, wherein the at least one cooling channel extends axially in a straight line between the fluid inlet and the fluid outlet where the cooling fluid exits the at least one cooling channel.

12. The rotary shaft device according to claim 1, wherein the housing comprises a cylindrical lateral wall and a distal end wall extending from the cylindrical lateral wall radially inward of the cylindrical lateral wall, the distal end wall defining, with the pressurization member, an access conduit configured to allow introduction of the cooling fluid into the pressurization reservoir.

13. The rotary shaft device according to claim 1, wherein the cooling fluid comprises a lubrication oil, preferably having a viscosity comprised between 5 cSt and 45 cSt, and more particularly equal to 15 cSt, at temperatures between 30 and 80° C., and more particularly between 40° C. and 50° C.

14. The rotary shaft device according to claim 6, wherein the at least one rolling bearing comprises:
an inner ring secured to the outer surface of the rotary shaft;
an outer ring radially offset relative to the inner ring and secured to the housing;
rolling elements interposed between the inner and outer rings and mounted in a rolling manner on both the inner and outer rings; and
a cage placed between the inner and outer rings, and maintaining a regular space between the rolling elements.

15. The rotary shaft device according to claim 14, wherein the inner ring at least partially covers the at least one cooling channel.

16. The rotary shaft device according to claim 15, wherein the at least one cooling channel is open radially towards the inner ring of the at least one rolling bearing, such that the cooling fluid passing through the at least one cooling channel is in direct contact with the inner ring.

17. A turbocharger capable of compressing a fluid, in particular a refrigerant, the turbocharger comprising the rotary shaft device according to claim 1.

18. The turbocharger according to claim 17, wherein the cooling fluid comprises the refrigerant.

19. A spindle or electro-spindle suitable for equipping a machine tool, the spindle or the electro-spindle comprising the rotary shaft device according to claim 1.

20. A pump for circulating fluid, the pump comprising the rotary shaft device according to claim 1.
